(19) United States
(12) Patent Application Publication
(10) Pub. No.: US 2010/0104841 A1
(43) Pub. Date: Apr. 29, 2010

(54) CONTAINER SEPARATOR PAD

(75) Inventor: Robert Howe Peterson, Hendersonville, TN (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington (DE)

(21) Appl. No.: 12/258,519

(22) Filed: Oct. 27, 2008

(51) Int. Cl. B32B 5/02; D04H 13/00

(52) U.S. Cl. 428/219; 442/361; 442/362; 442/364

(57) ABSTRACT

A separator pad that is shape-retaining, tear-resistant, non-porous, and non-toxic, for use in separating vertically stacked groups of containers, can be made from a calendered nonwoven sheet having one or more layers of synthetic bicomponent fibers having a first polymeric component and a second polymeric component that are arranged longitudinally along the fiber wherein the first polymeric component occupies at least a portion of the surface of the fiber, the first polymeric component has a lower melting or softening temperature than the second polymeric component and the first component is melted or softened in order to flow and fill any voids between the portion of the fibers containing the unmelted or unsoftened second polymer component.

### BACKGROUND OF THE INVENTION

1. Field of the Invention

The present invention relates to sheets or pads, for separating vertically stacked groups of containers.

2. Description of the Related Art

The canning or bottling of beverages typically requires that empty beverage containers be shipped from a container manufacturer to the beverage manufacturer where they are filled using an automated filling machine. In the case of canned soft drinks and beer, the empty cans are ordinarily sent to the beverage manufacturer in large quantities, and are typically stacked on pallets for shipment. To facilitate shipment to the beverage manufacturer, it is common for layers of equal-height cans to be tightly packed on a pallet, with each layer of cans being covered with a separator sheet which provides a surface for a next layer of cans to be placed. This process is repeated until the desired number of cans is stacked on the pallet. The stack of cans is then covered with a top frame, which can be made of plastic, wood, or other materials, and the pallet of stacked cans is secured for shipment. When using separator sheets of this type, a typical pallet may contain as many as about 20 layers having 400 cans per layer, or 8000 cans.

The separator pads must be designed to allow uncomplicated palletizing and de-palletizing of the cans while simultaneously preventing cans from slipping out from the stack and falling off the pallet. Furthermore, the material used must be compatible in terms of sanitation, non-flavor changing, and durability. Separator pads have previously been made from a chipboard material containing cellulose materials and a binder. Because the cellulose-based material is porous, insects and moisture could enter the sheet and cause contamination. Additionally, the chipboard sheets were sometimes found to emit an undesired flavor into the unfilled cans which, once filled, ultimately changed the flavor of the product. The chipboard sheets were also easily damaged, thus limiting their useful life. Separator pads have also previously been made from nonwoven sheets of synthetic monocomponent fibers. Although these sheets overcome some of the problems of the cellulose-based sheets, other problems were discovered. These sheets can have uneven surfaces causing cans to slip or stick to the sheet. This problem can be overcome with the additional step of coating the sheet with a film. These sheets also must have the edges sealed to prevent delamination and to bind loose fibers after the sheets are cut to useable size. Finally, these sheets can curl requiring a relaxing step.

What is needed is a separator pad that is strong, shape-retaining, tear-resistant, non-porous, non-toxic, insect and moisture resistant, and with minimal loose fibers and particle contaminants.

### SUMMARY OF THE INVENTION

This invention is directed to a separator pad that is shape-retaining, tear-resistant, non-porous, and non-toxic, for use in separating vertically stacked groups of containers, the separator pad comprising a calendered nonwoven sheet having one or more layers of synthetic bicomponent fibers having a first polymeric component and a second polymeric component that are arranged longitudinally along the fiber wherein the first polymeric component occupies at least a portion of the surface of the fiber, the first polymeric component has a lower melting or softening temperature than the second polymeric component and the first component is melted or softened in order to flow and fill any voids between the portion of the fibers containing the unmelted or unsoftened second polymer component.

### BRIEF DESCRIPTION OF THE DRAWING

The accompanying drawing, which is incorporated in and constitutes a part of this specification, and together with the description, serves to explain the principles of the invention.

FIG. 1 is a perspective view of several groups of vertically stacked cans separated by separator sheets or pads of the present invention.

### DETAILED DESCRIPTION OF THE INVENTION

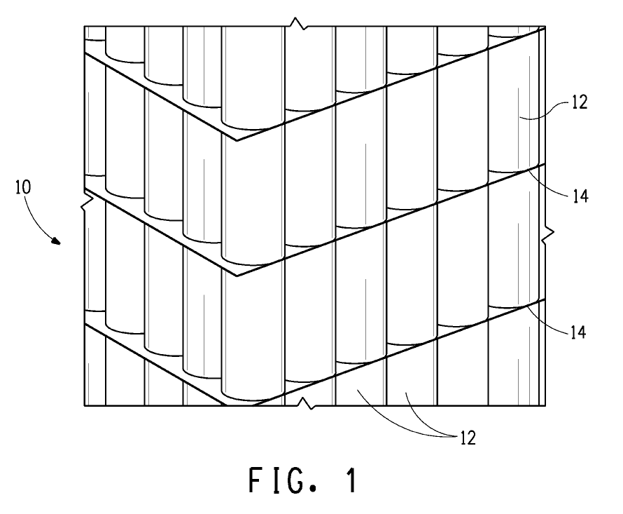

FIG. 1 illustrates vertically stacked groups of containers, indicated generally by the reference character 10, utilizing the separator pads of the present invention. While it will be understood by those of ordinary skill in the art that the groups of containers 12 can be any practical size and shape, and can be made from various materials such as metals or glass, the containers contemplated by the present invention are frequently cans, such as aluminum cans for soda or beer. Furthermore, the cans 12 are generally open-ended because they have not yet been shipped to the filling facility. Separator pads of the present invention are used to expedite this shipment.

In order to facilitate transport of the bundled cans 10, a group of cans 12 is placed upon a pallet, not shown, such that the cans 12 abut each other. A separator pad 14 such as the separator pad of the present invention is placed on top of cans 12, providing a base for a second group of cans 12. A second separator pad 14 can then be placed on top of the second group of cans 12, and the process repeated as desired to form a bundle 10 which can be secured for shipment to the manufacturer. To secure the bundled cans 10, a top frame, not shown, is placed on top of the top group of cans 12 and strapped down to a pallet, not shown. When packaged in this manner, a large number of cans may be transported at one time.

The separator pad of the present invention comprises a calendered nonwoven sheet having one or more layers of synthetic bicomponent fibers. The bicomponent fibers comprise a first polymeric component and a second polymeric component that are arranged longitudinally along the fiber wherein the first polymeric component occupies at least a portion of the surface of the fiber, the first polymeric component has a lower melting or softening temperature than the second polymeric component and the first component is melted or softened in order to flow and fill any voids between the portion of the fibers containing the unmelted or unsoftened second polymer component. This is distinctly different from a homopolymer such as polypropylene that shrinks and melts and has no higher melting structural fiber within the nonwoven fabric.

The first and second polymeric components are selected from the group of polyolefins such as polyethylene and polypropylene, polyesters such as polyethylene terephthalate, polyamides and copolymers thereof. A preferred combination is a first polymeric component of polyethylene and a second polymeric component of polyethylene terephthalate. These bicomponent fibers can be made of by a melt spinning process and converted into a nonwoven sheet by various methods known to those of ordinary skill in the art. A preferred melt spinning/sheet forming process is the spunbond process, as described in U.S. Pat. No. 6,831,025, in which fibers are melt spun and directly laid down on a collection screen in the form of a nonwoven sheet. Another melt spinning/sheet forming process is the melt blown process in which fibers are melt spun with the aid of a blowing gas and directly laid down on a collection screen in the form of a nonwoven sheet. The bicomponent fibers have a cross section wherein at least 10% of the surface of the bicomponent fiber is occupied by the first polymeric component. Preferred fiber cross sections are sheath-core and side-by-side. The nonwoven sheet is densified by calendering through the addition of heat and pressure to melt the first polymeric component in order to adhere the bicomponent fibers together and to eliminate the pores in the nonwoven sheet. Alternatively, a plurality of nonwoven sheets can be densified by laminating them together. Whether calendered or laminated, a separator pad can be made that has an appropriately slick (i.e., low friction) surface and is sufficiently stiff to overcome many of the disadvantages with existing separator pads faced by container manufacturers. The second polymeric component maintains its fiber integrity to provide strength to the sheet. Separator pads of the present invention have a basis weight of between 100 g/m² and 500 g/m².

Further advantages of the separator pads of this invention is the surprising attribute that after being densified and unwound for die cutting that the sheet laid very flat without having to go through a relaxation step. As noted above, the lower melting component provides a very smooth surface and therefore the need for an additional coating or laminating step to obtain a smooth surface is avoided. Further, the requisite strength is retained as the higher melting fibers remain embedded within the structure making it resistant to tearing or chipping. In short, the separator pads of the subject invention can be produced using significantly fewer steps that required in conventional pads. In its various embodiments, the present invention provides a separator pad that overcomes the deficiencies of the prior art and is strong, shape-retaining, tear-resistant, non-porous, non-toxic, and insect and moisture resistant. Furthermore, with the melting of the first polymeric component that adheres the bicomponent fibers together, the separator pad minimizes loose fibers and particle contaminants particularly after the pad is cut to useable size.

In another embodiment of the subject invention, antistatic characteristics can be improved by plasma treating or an antistatic film can be used in the densification process.

### EXAMPLE

Hereinafter the present invention will be described in more detail in the following example.

A separator pad of the present invention was made from a calendered spunbond sheet of synthetic bicomponent fibers. The bicomponent fibers were spunbond in a manner similar to the process described in U.S. Pat. No. 6,831,025. The bicomponent fibers were made into sheath-core cross section fibers from a first polymeric component of polyethylene in the sheath and a second polymeric component of polyethylene terephthalate in the core. The spunbond web had a basis weight of 68 g/m². Four layers of this spunbond web were calendered together on a calendering machine with a top smooth roll at a temperature of 180° C. and a bottom smooth roll at a temperature of 160° C., a pressure of 10-25 N/cm², and a line speed of 9-15 m/min. The resulting separator pad was cooled in a flat position before winding up on a roll. The separator pad had a basis weight of 272 g/m².

What is claimed is:

1. A separator pad for use in separating vertically stacked groups of containers, the separator pad, comprising a densified nonwoven sheet having one or more layers of synthetic bicomponent fibers having a first polymeric component and a second polymeric component that are arranged longitudinally along the fiber, wherein the first polymeric component occupies at least a portion of the surface of the fiber, the first polymeric component has a lower melting or softening temperature than the second polymeric component and the first component is melted or softened in order to flow and fill any voids between the portion of the fibers containing the unmelted or unsoftened second polymer component.

2. The separator pad according to claim 1, wherein the first and second polymeric components are selected from the group polyolefins, polyesters, polyamides and copolymers thereof.

3. The separator pad according to claim 2, wherein the polyolefins are selected from the group comprising polyethylene, polypropylene and copolymers thereof.

4. The separator pad according to claim 2, wherein the polyesters are selected from the group comprising polyethylene terephthalate and copolymers thereof.

5. The separator pad according to claim 2, wherein the first polymeric component is polyethylene and the second polymer component is polyethylene terephthalate.

6. The separator pad according to claim 2, wherein the first polymeric component is a copolymer of polyethylene terephthalate and the second polymer component is polyethylene terephthalate.

7. The separator pad according to claim 1, wherein the bicomponent fiber comprises a structure selected from the group consisting of sheath-core or side-by-side cross section.

8. The separator pad according to claim 1, wherein the first polymeric component occupies at least 10% of the surface of the bicomponent fiber.

9. The separator pad according to claim 1, wherein the bicomponent fibers are melt spun.

10. The separator pad according to claim 9, wherein the melt spun bicomponent fibers are selected from the group consisting of spunbond or meltblown.

11. The separator pad according to claim 1, wherein the separator pad has a basis weight between 100 g/m² and 500 g/m².
